(19) United States
(12) Patent Application Publication
(10) Pub. No.: US 2013/0073075 A1
(43) Pub. Date: Mar. 21, 2013

(54) CNC MACHINE WITHOUT AN OPERATOR CONSOLE

(71) Applicants: Jean-Philippe Besuchet, Neuchatel (CH); Konrad Meier, Ipsach (CH); Markus Kohler, Bruegg (CH)

(72) Inventors: Jean-Philippe Besuchet, Neuchatel (CH); Konrad Meier, Ipsach (CH); Markus Kohler, Bruegg (CH)

(73) Assignee: MIKRON AGIE CHARMILLES AG, Nidau (CH)

(21) Appl. No.: 13/618,463

(22) Filed: Sep. 14, 2012

(30) Foreign Application Priority Data
Sep. 17, 2011 (EP) 11181728.4

(51) Int. Cl. G05B 15/02

(52) U.S. Cl. 700/180

(57) ABSTRACT

A CNC machine, or CNC machining centre, for the automated and computer-controlled production or machining of components. The CNC machine does not have any operator module attached to it, or any operator module connected to it, that remains permanently connected to the CNC machine during the operation of the CNC machine.

### BACKGROUND OF THE INVENTION

The invention relates to a CNC milling machine, preferably a CNC machining centre.

In machine tool construction, CNC milling machines, CNC lathes and corresponding machining centres are currently state of the art. CNC (computerized numerical control) machines are machine tools that are controlled by means of a computer and that produce desired workpieces from blanks or components (e.g. aluminium blocks). In the case of CNC machines, the geometric form of the workpieces to be produced—i.e. to be milled or turned on a lathe—is normally loaded into the memory of the machine tool control system (together with further machining data, such as geometry of the tools, rotational speeds, feed rate, etc.) and stored there. The control system of the CNC machine can thereupon produce the desired workpieces from the blank with great precision, in an automatic and computer-controlled manner. The advantage in comparison with mechanically controlled machines lies, on the one hand, in the greater precision in the machining of components, in the capability to produce substantially more complex components, in the substantially greater speed of machining the components, and also in the high degree of automation in the machining process. It is precisely the latter that ensures high productivity with constant quality, which is favourable for successful large-scale production. Further, CNC machine tools can also be connected to each other to constitute production systems.

With the emergence of computer control systems at the end of the 1970s, and particularly in the 1980s, CNC machines developed progressively from mechanically controlled machine tools, or machine tools equipped with analogue technology. Before the actual computer control systems, electromechanical control systems were used in mechanically controlled machine tools. Since, at the start of control system technology, even these electromechanical systems were not satisfactory to have with conventional, electrical or electromechanical switches and the like, conventional, manually operated machine tools were provided, for example, with portable and connectable control consoles having analogue switching technology. An example of this is shown by U.S. Pat. No. 3,733,961. The control system disclosed therein—consisting of analogue switching technology—could be connected to a variety of conventional machines tools, such that a certain degree of automation—actually very limited by current standards—could be achieved. A main advantage of such a portable control system, clearly, was that it could be used on a variety of machine tools. On the other hand, the improved, i.e. automated, operation of a machine tool in the sense of U.S. Pat. No. 3,733,961 was possible only when and also for as long as the connectable control console was and remained connected to the respective machine tool.

When computer technology came in, analogue switching technology was taken out of machine control systems. Owing to the capability to store in memory, even complex components could be produced in an automated manner.

In the past decades, ever more modern and more high-performance CNC machines have been developed progressively. What has remained for all of them, however, is their connection to the computer: all known appliances have an operator panel for controlling the CNC machine. This operator panel is normally very similar to a computer, and has an operator display and keys (possibly in the form of a touch-screen) for operating the CNC machine.

DE 38 13 590 A1 discloses a machine tool having a machine control system that is installed in a separate control panel and connected to the machine tool via a connecting line. Moreover, this document discloses a remote control part realized as a portable manual control device. The remote control part is equipped with a keypad, for inputting commands and data, and with a display. The remote control part can wirelessly exchange data with the control system of the machine. The remote control part can be used for executing certain operations on the machine tool, which are limited in number (e.g. moving an axis of the machine). Despite the remote control part, this machine tool, likewise, has an operator panel that is fixedly connected to the machine tool via a connecting line and that is used for the actual control and programming of the machine.

EP 1 257 886 discloses a tool measuring device or a coordinate measuring device having a universal operator unit. This operator unit is equipped with an operator console, together with a monitor screen. The operator unit is connected to the machine tool, e.g. a CNC milling machine, by means of an optical waveguide. However, in the case of this teaching from the prior art, also, the machine tool is equipped with a computer that, according to the description and figures, is designed as a conventional PC and, in particular, has a corresponding input unit (i.e. specifically, monitor screen and keyboard). Besides the universal connectable operator unit, therefore, the machine tool according to EP 1 257 886 has its own, fixedly built-in console for operating (e.g. programming) the machine.

The present invention is based on the object of further simplifying the operating of a CNC machine.

### SUMMARY OF THE INVENTION

This object is achieved by providing a CNC machine comprising a separate operator module temporarily connected to the CNC machine by radio or cable, for the purpose of programming and/or control, wherein the CNC machine does not have any operator module attached to it, or any operator module connected to it, that remains permanently connected to the CNC machine during the operation of the CNC machine and the CNC machine also does not have attached to it or connected to it any operator display, preferably LCD monitor screen or touch-screen, and/or input element, preferably keyboard.

### DETAILED DESCRIPTION

The idea according to the invention includes that the CNC machine—which is designed and suitable for automated and computer-controlled production or machining of blanks—does not have any operator module permanently attached or connected to it that also remains permanently connected to the CNC machine during the operation of the CNC machine.

A CNC machine realized according to the invention has the advantage that it does not have to be equipped and supplied with an operator module (e.g. monitor screen and input means, such as touch-screen or keyboard). The producer of the CNC machine can thus save the production and equipment costs associated therewith and, as a result, can also reduce the sale price. Instead, the producer of the CNC machine supplies a separate operator module that can be connected to this machine tool in an ad hoc manner for the purpose of programming and/or selective control of the CNC machine. Since the customers of the CNC machine producer normally purchase several CNC machines, or have several CNC machines in their enterprise, the purchase of one separate operator module, or possibly two modules, is sufficient for operating the entire pool of machine tools according to the invention.

The CNC machine according to the invention can also be a so-called CNC machining centre, also called a production centre (e.g. a 5-axis machining centre), that is equipped for automated operation. Such a CNC machining centre can be equipped, for example, for the complete machining of blanks. A CNC machining centre can comprise, for example, a rotatable and pivotable machine table, a multi-axially movable tool spindle, as well as automatic tool and workpiece changers (e.g. robots).

In the present application, an operator module is to be understood to be a unit used for programming and general operation of the CNC machine. The functions of the operator module of the CNC machine according to the invention correspond to those of known and fixedly built-in operator consoles on conventional CNC machines available on the market.

A permanent connection according to the preceding description is understood to include both wireless connections (e.g. via radio) and cable connections.

The CNC machine according to the invention, preferably a CNC machining centre, intended for automated and computer-controlled production or machining of components, is characterized in that it does not have any operator module attached or connected to it that remains or has to remain permanently connected to the CNC machine during the operation of the CNC machine. This means that the CNC machine according to the invention does require an operator module for programming and other operation of the CNC machine. However, during the normal operation of the machine tool (e.g. automated milling or lathe turning of blanks, such as turbine blades etc.), there is no control panel, operator module or operator console etc. that is attached to the machine or connected to it (e.g. by radio or cable). The CNC machine thus operates autonomously and independently of an operator console. During this time, the machine tool is also not connected to such an operator console, such that also no monitor screen displays, for example, the operating state (rotational speeds, feed rate, energy consumption, etc.) or can be directly manipulated via an input unit. Clearly, the idea according to the invention includes that, if necessary, the operating personnel can connect the CNC machine according to the invention to the separate operator module (e.g. via radio or cable), in order thus to control or manipulate the CNC machine. Also included, for this purpose, is that, for example, operating data, the detailed status, or possibly—in the case of malfunctions or error messages—also diagnostic data relating to the CNC machine can be displayed on the separate operator module and controlled by the operating personnel. It is then possible for the operating personnel to intervene selectively in the operation of the CNC machine if necessary.

According to the invention, it can be provided, in the case of a connection being established (or set up) between a CNC machine and the separate operator module, that the running CNC machine does not interrupt its operation (i.e. the CNC machine continues to machine, e.g. to mill, the inserted component without interruption).

In another variant of the applied invention, it can also be provided, on the other hand, that, in the case of a connection being established (or set up) between a running CNC machine and a separate operator module, the running CNC machine interrupts its operation (in a controlled manner).

The CNC machine according to the invention therefore also does not have any operator display permanently attached to it, or any operator display connected to it—e.g. via cable or radio. It thus also does not have any LCD monitor screen or touch-screen. Nor does it have an input element such as, for example, a keyboard.

On the other hand, the CNC machine according to the invention can be coupled to a separate operator module for the purpose of programming, operation and/or control. Preferably, this operator module according to the invention can be coupled or connected to the CNC machine via radio or cable.

The operator module can have an operator display and an input means, preferably keys or a touch-screen, or a combination thereof.

Clearly, it is also provided that the CNC machine has a prescribed emergency stop button and an indicator for indicating operation/non-operation on the CNC machine itself. It must be pointed out that, clearly, such a button and such an indicator (e.g. one or more lamps) cannot be used to operate the CNC machine, in particular either to program or control the CNC machine.

The CNC machine according to the invention, or the CNC machining centre according to the invention, can be a milling machine or a lathe.

1. CNC machine comprising a separate operator module temporarily connected to the CNC machine by radio or cable, for the purpose of programming and/or control, wherein the CNC machine does not have any operator module attached to it, or any operator module connected to it, that remains permanently connected to the CNC machine during the operation of the CNC machine and the CNC machine also does not have attached to it or connected to it any operator display, preferably LCD monitor screen or touch-screen, and/or input element, preferably keyboard.

2. CNC machine according to claim 1, wherein the separate operator module has an operator display and input means comprising keys or touch-screen.

3. CNC machine according to claim 1, further including an emergency stop button and an indicator for indicating operation/non-operation of the CNC machine are fitted on the CNC machine.

4. CNC machine according to claim 1, wherein the CNC machine is a milling machine or a lathe.

5. CNC machine according to claim 1, wherein, in the case of a connection being established between the running CNC machine and the separate operator module, the running CNC machine does not interrupt its operation.

6. CNC machine according to claim 1, wherein, in the case of a connection being established between the running CNC machine and the separate operator module, the running CNC machine interrupts its operation in a controlled manner.

7. CNC machine according to claim 1, wherein the operator module has an operator display and input means comprising keys or touch-screen, and is connected to a variety of CNC machines for the purpose of respective programming and/or control of the CNC machines by radio or cable.
